(19) United States
(12) Patent Application Publication
(10) Pub. No.: US 2009/0001680 A1
(43) Pub. Date: Jan. 1, 2009

(54) Motor Vehicle

(76) Inventors: Reinhard Buhl, Bohmte (DE); Reinhard Richter, Bohmte (DE); Werner Schmudde, Bersenbruck (DE)

Correspondence Address: MCGLEW & TUTTLE, PC, P.O. BOX 9227, SCARBOROUGH STATION, SCARBOROUGH, NY, 10510-9227, US

(21) Appl. No.: 10/595,304

(22) PCT Filed: Oct. 11, 2004
(86) PCT No.: PCT/DE04/02254

§ 371 Date: Apr. 6, 2006

(30) Foreign Application Priority Data
Oct. 15, 2003 (DE) 103 48 645.3

(51) Int. Cl. B60G 7/00

(52) U.S. Cl. 280/124.134

(57) ABSTRACT

A motor vehicle, especially a utility vehicle, with a vehicle chassis (3) as well as with a rear axle arrangement (2) having a rigid axle (1). A Panhard rod (8) for supporting lateral forces or a control arm for supporting longitudinal forces is arranged between the vehicle chassis (3) and the rigid axle (1). The motor vehicle has the Panhard rod (8), which is directly articulated to the vehicle chassis (3) with an axial joint (11) in a pivotingly movable manner or by a control arm. The Panhard rod (8) is articulated to the rigid axle directly with an axial joint (11) in a pivotingly movable manner.

### CROSS REFERENCE TO RELATED APPLICATIONS

This application is a United States National Phase application of International Application PCT/DE 2004/002254 and claims the benefit of priority under 35 U.S.C. § 119 of German Application DE 103 48 645.3 filed Oct. 15, 2003, the entire contents of which are incorporated herein by reference.

### FIELD OF THE INVENTION

The present invention pertains to a motor vehicle, especially a utility vehicle, with a vehicle chassis and a rear axle arrangement having a rigid axle. A so-called Panhard rod is arranged here between the vehicle chassis and the rigid axle. In addition or in alternative rear axle arrangements, a longitudinal control arm arranged between the axle and the vehicle chassis may be used.

### BACKGROUND OF THE INVENTION

Rear axle arrangements with a rigid axle continue to be used in motor vehicles, especially utility vehicles, with a vehicle chassis. To support lateral forces acting on the rear axle, which result, for example, from travel in curves, Panhard rods are used, in general, between the vehicle chassis and the rigid axle. By contrast, longitudinal control arms are used to support longitudinal forces occurring during travel between the vehicle chassis and the rigid axle. To compensate the relative motions between the rigid axle and the vehicle chassis, which result from the spring excursion, the Panhard rod as well as the longitudinal control arm are connected in a pivotingly movable manner with the rigid axle, on the one hand, and the vehicle chassis, on the other hand.

A motor vehicle of this class with a Panhard rod is known from DE 196 24 242 A1, where the Panhard rod has radial joints at its respective ends, with which it is connected to the rigid axle, on the one hand, and to the vehicle chassis, on the other hand, in an articulated manner. The connection of the Panhard rod to the vehicle chassis, in particular, by means of a radial joint requires, on the chassis side, a separate bearing block, which causes a disadvantageous increase in the weight of the vehicle. This bearing block requires, furthermore, an additional assembly effort due to screwing and/or welding operations, associated with additional attached parts and manufacturing steps. The machining of flange or optionally cone connections is, in particular, very complicated, which leads to a disadvantageous increase in the costs. Furthermore, the radial joints used permit only a small pivot angle between the bearing and the axis of the Panhard rod, as a result of which very accurate and, as a result, cost-increasing manufacturing tolerances are necessary.

These drawbacks, described for the Panhard rod, also apply to the longitudinal control arms, which are likewise shown in DE 196 24 242 A1. These longitudinal control arms are likewise connected by means of two radial joints to the rigid axle, on the one hand, and to the vehicle chassis, on the other hand, in a pivotingly movable manner.

### SUMMARY OF THE INVENTION

The object of the present invention is to provide a connection of a Panhard rod or a longitudinal control arm, which is arranged between a vehicle chassis and a rigid axle associated with a rear axle arrangement, which connection effectively avoids the described drawbacks of the prior art and has a simple design.

This object is accomplished, based on a motor vehicle according to the present invention with a Panhard rod arranged between the vehicle chassis as well as a rigid axle. The direct, pivotingly movable connection of the Panhard rod to the vehicle chassis with an axial joint. The use of bearing blocks, flanges or the like to connect the Panhard rod to the vehicle chassis is advantageously avoided due to this arrangement. In direct relationship hereto, this connection reduces the weight and the number of components and thus requires fewer assembly and manufacturing steps, as a result of which the costs are, on the whole, substantially reduced.

In an advantageous embodiment, the axial joint is designed as a ball and socket joint, where the ball and socket joint has a ball pivot with a joint ball. The joint ball is received in a bearing shell received in a bearing housing in a slidingly and pivotingly movable manner. The bearing housing is provided, furthermore, with a threaded bolt, which is received in a hole provided on the vehicle chassis. The bearing housing can thus be screwed to the vehicle chassis, for example, with a threaded nut by means of the threaded bolt. A wrench attachment is advantageously provided for this purpose on the bearing housing. This pivotingly movable connection makes it possible to compensate greater tolerances compared to the conventional connection because of the broad pivoting range of the axial joint. Furthermore, this form of connection minimizes the necessary connection parts and assembly steps to a minimum, as a result of which the manufacturing costs are further reduced.

In a preferred embodiment, the Panhard rod is formed from a tube with two joint pieces designed as a radial joint and an axial joint, wherein the joint pieces are inserted into the tube by means of a bearing journal or ball pivot associated with the joint piece. An additional tolerance compensation is achieved here by at least one joint piece being held displaceably in the tube, as a result of which longitudinal adjustment of the Panhard rod is made possible. The joint piece is held in an especially simple manner by means of a clamped connection between the tube and the end of the bearing journal or ball pivot of one of the two joint pieces, which said end is inserted into the tube. The clamped connection is preferably formed from a clip as well as a slotted end of the tube, which slotted end cooperates with the clip, wherein the clip compresses the slotted end of the tube against the end of the bearing journal or ball pivot of one of the two joint pieces, which said end is inserted into the tube.

If the motor vehicle according to the present invention is provided, for supporting longitudinal forces, with a control arm, for example, a longitudinal control arm, which is arranged between the rigid axle and the vehicle chassis, this is characterized by the direct, pivotingly movable articulation of the control arm to the rigid axle with an axial joint. Connection of the control arm to the rigid axle, which is held in a simple manner and comprises only a few individual parts, is achieved in this arrangement as well and the number of assembly and manufacturing steps is reduced in conjunction with a substantial cost reduction.

Just like the Panhard rod, the axial joint of the control arm is also designed as a ball and socket joint with a joint ball having a ball pivot, wherein the joint ball is received in a bearing shell received in a bearing housing in a slidingly and pivotingly movable manner. The threaded bolt provided on the bearing housing is received here in a hole on the rigid axle and can thus likewise be screwed with a threaded nut to the rigid axle. Increased tolerance compensation can be achieved with this axial joint in the control arm as well.

The design of the control arm may advantageously correspond to that of the Panhard rod, and an additional tolerance compensation can be achieved here by a longitudinal adjustment. For example, a clamped connection may also be provided for the longitudinal adjustment in such a way that at least one joint piece is inserted into the control arm designed as a tube and the end of the tube is advantageously designed as a slotted end.

Other measures improving the present invention are described in the subclaims or will be represented in greater detail below with the description of a preferred exemplary embodiment of the present invention on the basis of the figures.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a top view of the schematic design of a rear axle arrangement with a Panhard rod according to the present invention;

FIG. 2 is the rear view of the schematic design of a rear axle arrangement with a Panhard rod according to the present invention according to arrow A in FIG. 1;

FIG. 3 is a three-dimensional detail view of a Panhard rod according to the present invention; and

FIG. 4 is a two-dimensional view of a Panhard rod according to the present invention with connection to the vehicle chassis.

### DESCRIPTION OF THE PREFERRED EMBODIMENT

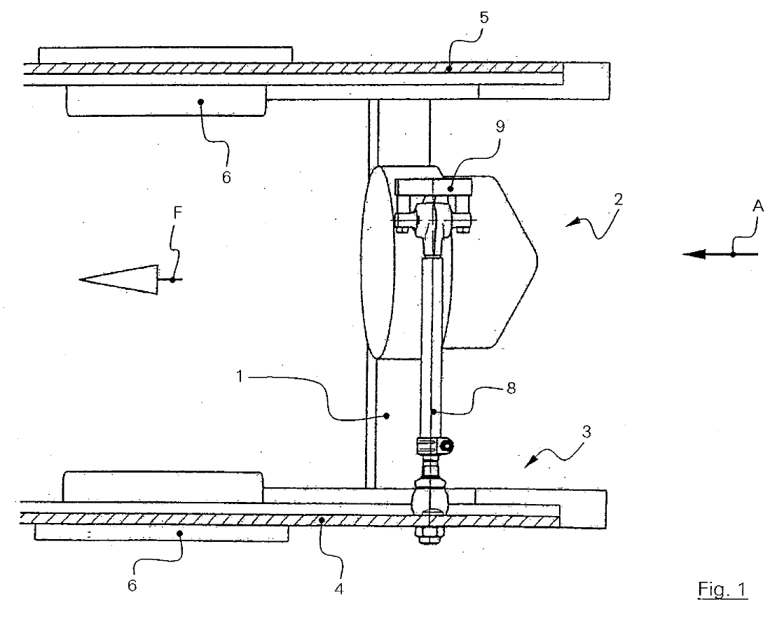

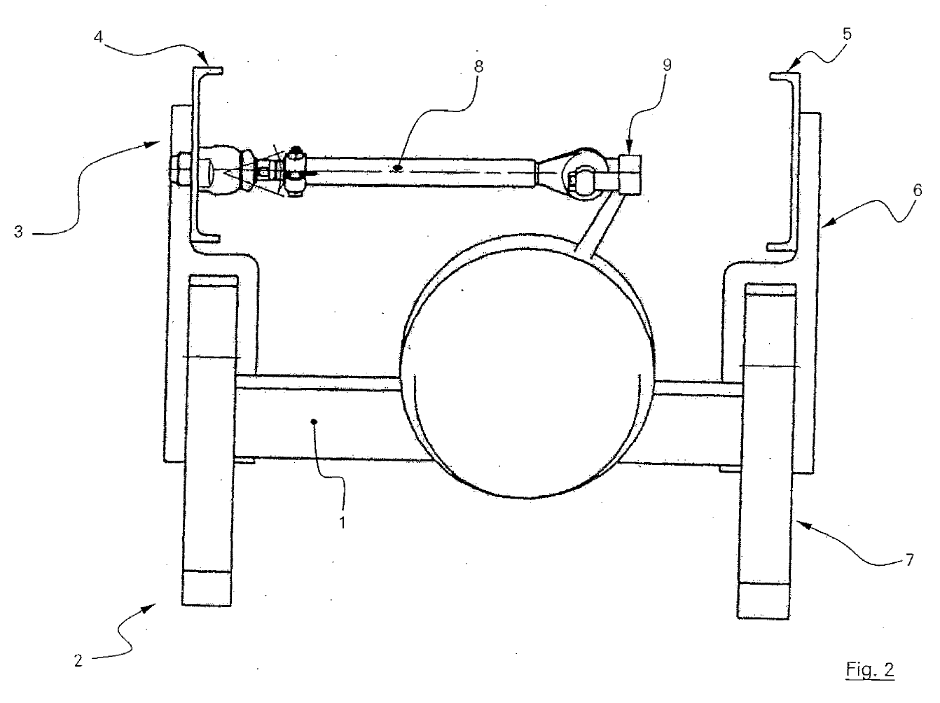

Referring to the drawings in particular, FIGS. 1 and 2 show two different views of the schematic design of a rear axle arrangement 2 having a rigid axle 1 with a vehicle chassis 3. The vehicle chassis 3 comprises here essentially a left and right longitudinal control arm 4, 5 each, which receives the spring 7 connecting the rigid axle 1 to the vehicle chassis via a bracket 6 each. A Panhard rod 8, which is connected on the axle side to a bracket 9 associated with the rigid axle 1, is arranged between the vehicle chassis 3 and the rigid axle 1. At the end of the Panhard rod 8 facing away from the rigid axle 1, the Panhard rod is articulated directly to the vehicle chassis 3.

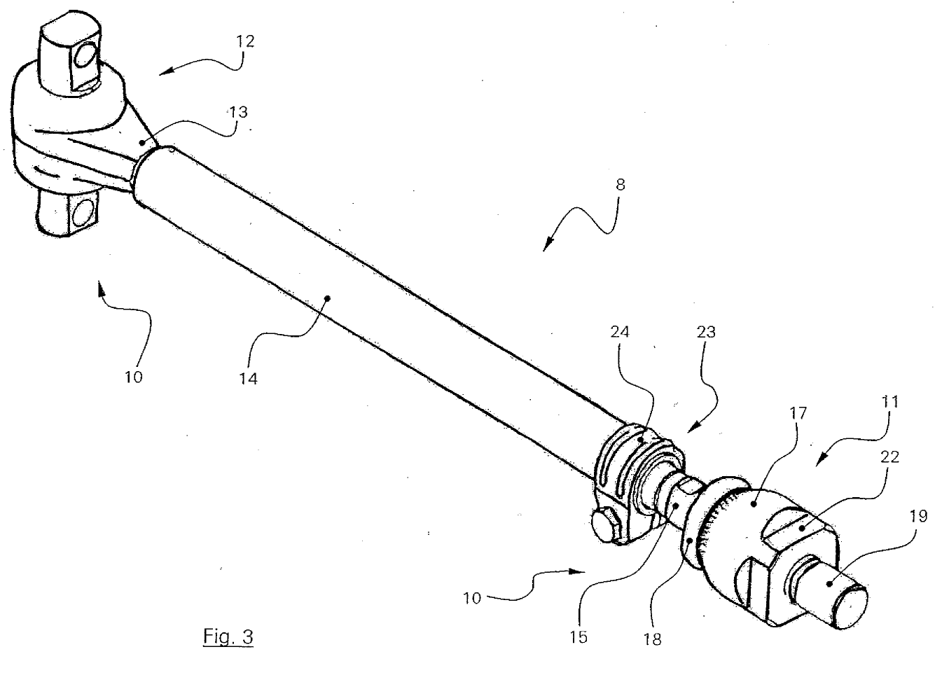

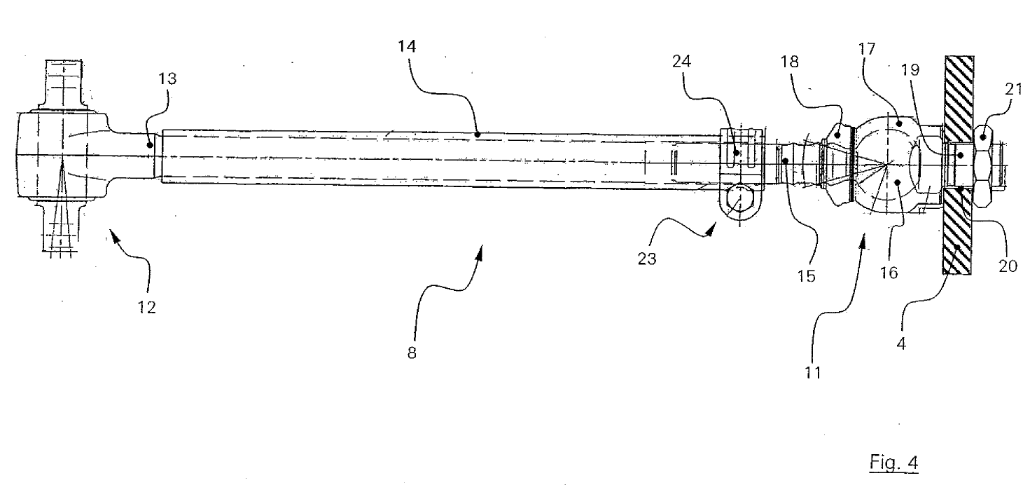

As can be determined from FIG. 3 and FIG. 4, the Panhard rod 8 has a joint piece 10 each at the two ends, the axle-side joint piece 10 being designed as an axial joint 111 and the chassis-side joint piece 10 being designed as a radial joint 12. The radial joint 12 and the axial joint 11 are connected by means of a tube 14, and the joint pieces 10 with their bearing journals 13 are inserted into the openings of the tube 14, which are located on both sides.

The axial joint 11 is formed essentially from a bearing journal, which is designed as a ball pivot 15, with a joint ball 16, with is received in a bearing shell (not shown) received in a bearing housing 17 in a slidingly and pivotingly movable manner. The opening gap between the ball pivot 15 and the bearing housing 17 is sealed with a sealing bellows 18 against the entry of dirt and the escape of lubricant.

The bearing housing 17 is provided with a threaded bolt 19, which is received on the vehicle chassis side in a hole 20 of the longitudinal control arm 4. The bearing housing 17 is screwed by means of a threaded nut 21 to the vehicle chassis 3. A wrench attachment 22 is provided for this purpose as an aid on the bearing housing 17.

The ball pivot 15 is inserted into the opening of the tube 14 and is fixed against the tube 14 by means of a clamped connection 23. The clamped connection 23 is designed in a simple manner as a clip 24, which compresses the preferably slotted end (not shown) of the tube 14 against the ball pivot 15. For better hold of the ball pivot 15 in the tube 14, the area of the ball pivot 15 that is inserted into the tube 14 may be, for example, profiled or provided with a thread. Furthermore, the inner surface of the tube end, which surface cooperates with the ball pivot 15, may likewise be profiled or provided with a thread. The ball pivot 15 can thus be positioned in different positions in relation to the tube 14, i.e., different lengths of the Panhard rod 8 can be set within certain limits. The radial joint 12 is, by contrast, connected rigidly to the tube 14 via, e.g., a slip joint or the like. However, this connection could also be designed as an adjustable design similar to that of the axial joint 12 for a broader range of adjustment of the Panhard rod.

On the whole, the connection of the Panhard rod 8 to the vehicle chassis 3 discloses a very simple design with reduced number of components. Only one screw connection is provided. Thus, mounting on the vehicle chassis 3 requires little design effort and manufacturing technical effort. Only the mounting hole 20 on the vehicle chassis is to be provided. These measures thus minimize the costs for the manufacture and the assembly of the Panhard rod 8. The fact that standard components are essentially used, even for the axial joint, contributes to this as well.

The use of an axial joint instead of, e.g., a radial joint makes it possible to broaden the manufacturing tolerances, which likewise leads to a cost reduction. This is due to the design of an axial joint, because an axial joint has a broader pivoting range in all directions of pivoting compared to a radial joint and is thus less sensitive to an offset installation position without the function being compromised.

Besides the possibility of compensating angular positions of the Panhard rod 8, compensation in the axial direction of the Panhard rod 8 has been additionally created by the above-described longitudinal adjustability of the Panhard rod 8 by means of the clamping 23 of the ball pivot 15 within the tube 14 in different positions of the two components in relation to one another. This additionally simplifies the mounting of the Panhard rod 8 and thus contributes to the reduction of the costs.

As an alternative to the exemplary embodiment shown in FIGS. 3 and 4 with the threaded bolt 19 associated with the bearing housing 17 as well as with the joint ball 16 arranged at the ball pivot 15, it is, for example, also possible, in principle, to transpose the arrangement of the bearing housing 17 and the joint ball 16. Thus, it is also possible to provide the bearing housing with a pivot, which is inserted into the tube 14. By contrast, the joint ball is provided with a ball pivot, which has a threaded end piece, which is received in the hole 20 of the vehicle chassis 3 and is screwed to this with a threaded nut 21.

It is also possible, in principle, to transpose the radial joint 12 and the axial joint 11, i.e., the radial joint of the Panhard rod 8 is articulated on the axle side and the axial joint 11 to the vehicle chassis 3. Likewise, it is also possible to use an axial joint at both the rigid axle 1 and the vehicle chassis 3. However, the embodiment described and shown in the figures is generally preferred for reasons of guiding the axle and the guiding of forces. However, the articulation to the vehicle chassis is brought about with a radial joint and the articulation to the rigid axle with an axial joint in a longitudinal control arm for these stated reasons. Just as the Panhard rod 8, the longitudinal control arm is essentially provided with a radial joint and an axial joint, which are likewise connected to a tube, and it is arranged at approximately in parallel to the direction of travel F between the rigid axle 1 and the vehicle chassis 3. The design of the axial joint and the connection thereof to the rigid axle are the same as in the above-described exemplary embodiment of the axial joint 11 of the Panhard rod 8, which joint 11 is articulated to the vehicle chassis 3. For example, longitudinal displaceablity can also be embodied here by means of a clamped connection.

The use of an axial joint for the axle-side or chassis-side connection of the Panhard rod or the longitudinal control arm leads as an additional advantage to the relief of the radial joint inserted on the opposite end of the control arm or of the Panhard rod as well as of the control arm structure. This results from the low moduli of torsion of the plain bearing of the axial joint, which are transmitted during the operation.

While specific embodiments of the invention have been shown and described in detail to illustrate the application of the principles of the invention, it will be understood that the invention may be embodied otherwise without departing from such principles.

1. A motor vehicle comprising:
a vehicle chassis;
a rear axle arrangement having a rigid axle;
a Panhard rod or control arm arranged between said vehicle chassis and said rigid axle for supporting lateral forces; and
an axial joint, said Panhard rod or control arm being directly articulated to said vehicle chassis via said axial joint in a pivotingly movable manner.

2. (canceled)

3. A motor vehicle in accordance with claim 1, wherein said axial joint comprises a ball and socket joint.

4. A motor vehicle in accordance with claim 3, wherein said ball and socket joint has a ball pivot with a joint ball, which is received in a bearing housing in a slidingly and pivotingly movable manner.

5. A motor vehicle in accordance with claim 4, wherein a bearing shell, which receives said joint ball in a slidingly and pivotingly movable manner, is arranged in said bearing housing.

6. A motor vehicle in accordance with claim 4, wherein said bearing housing is fastened to said vehicle chassis or to said rigid axle.

7. A motor vehicle in accordance with claim 4, wherein a threaded bolt is arranged at said bearing housing.

8. A motor vehicle in accordance with claim 4, wherein a wrench attachment is formed on said bearing housing.

9. A motor vehicle in accordance with claim 7, wherein said threaded bolt is received in a hole on said vehicle chassis or on said rigid axle.

10. A motor vehicle in accordance with claim 1, wherein said Panhard rod or said control arm is formed from a tube and a radial joint at an end thereof and with said said axial joint at another end thereof, wherein said joint pieces are inserted into said tube on both sides by means of a bearing journal or a ball pivot.

11. A motor vehicle in accordance with claim 10, wherein at least one of said radial joint at an end and axial joint at another end is arranged displaceably in said tube of said Panhard rod or of said control arm and can be fixed by means of a clamped connection in relation to said tube.

12. A motor vehicle in accordance with claim 11, wherein said clamped connection is formed by a clip and a slotted end of said tube, which said slotted end cooperates with said clip, wherein said slotted end of said tube is held by said clip under the action of a radial force against an end of a bearing journal and/or said ball pivot of one of said two joint pieces, which said end is inserted into said tube.

13. A motor utility vehicle, comprising:
a vehicle chassis;
a rear axle arrangement having a rigid axle;
a connection rod;
a first joint directly connecting said connection rod to said vehicle chassis in a pivotingly movable manner; and
a second joint directly connecting said connection rod to said rear axle arrangement in a pivotingly movable manner, one of said first joint and said second joint being an axial joint.

14. A motor utility vehicle according to claim 13, wherein said connection rod is a control arm.

15. A motor utility vehicle according to claim 13, wherein said connection rod is a Panhard rod.

16. A motor utility vehicle in accordance with claim 13 wherein said axial joint comprises a ball and socket joint having a ball pivot with a joint ball, which is received in a bearing housing in a slidingly and pivotingly movable manner and wherein a bearing shell, which receives said joint ball in a slidingly and pivotingly movable manner, is arranged in said bearing housing.

17. A motor utility vehicle in accordance with claim 16, wherein said bearing housing is fastened to said vehicle chassis or to said axle arrangement with a threaded bolt arranged at said bearing housing and wherein a wrench attachment is formed on said bearing housing.

18. A motor utility vehicle in accordance with claim 17, wherein said connection rod is formed from a tube with said axial joint as a ball pivot joint connected to said tube and the other one of said first joint and said second joint is a radial joint formed as a bearing journal connected to said tube.

19. A motor utility vehicle in accordance with claim 18, wherein at least one of said radial joint and said axial joint is arranged displaceably in said tube and can be fixed by means of a clamped connection in relation to said tube.

20. A motor utility vehicle in accordance with claim 19, wherein said clamped connection comprises a clip and a slotted end of said tube, which said slotted end cooperates with said clip, wherein said slotted end of said tube is held by said clip under the action of a radial force against an end of a bearing journal and/or said ball pivot of one of said two joint pieces, which said end is inserted into said tube.

21. A motor utility vehicle in accordance with claim 13, wherein said connection rod is a control arm or a Panhard rod formed from a tube with said axial joint as a ball pivot joint connected to said tube and the other one of said first joint and said second joint is a radial joint formed as a bearing journal connected to said tube, wherein at least one of said radial joint and said axial joint is arranged displaceably in said tube and can be fixed by means of a clamped connection in relation to said tube.
